(19) United States
(12) Patent Application Publication
(10) Pub. No.: US 2022/0122569 A1
(43) Pub. Date: Apr. 21, 2022

(54) Method and Apparatus for the Composition of Music

(71) Applicant: Matthew Caren, Palo Alto, CA (US)

(72) Inventor: Matthew Caren, Palo Alto, CA (US)

(21) Appl. No.: 17/406,974

(22) Filed: Aug. 19, 2021

Related U.S. Application Data
(60) Provisional application No. 63/092,818, filed on Oct. 16, 2020.

(51) Int. Cl. G10H 1/00; G10H 1/38

(52) U.S. Cl. CPC G10H 1/0025; G10H 2210/145; G10H 2210/571; G10H 1/38

(57) ABSTRACT

A system and method for making musical decisions is provided. The approach is based on algorithms which compose music driven by an input of desired emotional tension over time. A method for abstraction and quantification of musical structures is detailed, as well as the application of this method in a generative algorithm that produces musical sequences. The overall goal of this method is to use a set of abstractions and guidelines to generate emotionally appropriate new music in real time.

### BACKGROUND OF THE INVENTION

Music is a unique medium with a powerful ability to shape a listener's emotions. Movies, plays, and video games would all be profoundly different experiences without their musical accompaniments that enhance, alter, and transform a subject's perception of the media. Music can magnify the emotional content of a work, building suspense or amplifying triumph or defeat; it can act as an indicator, foreshadowing an event or providing information about a character or their intentions; it can even completely transform the nature of an experience, converting an otherwise dark and menacing scene into a comedic and lighthearted one, or vice versa.

These synergies between music and other mediums rely on the intimate connections between music, non-music media, and the user/audience's emotions. The creation of music in this interdependent setting is a delicate task that requires an in-depth knowledge of music's emotional content. In the present invention, a jazz theory approach to music composition driven by a central “tension/release” value is used in order to create novel musical sequences that are both musically effective and emotionally appropriate. The fluidity and adaptability of jazz theory also allows the algorithm to react to sudden or drastic changes in input. By parameterizing emotion as a single tension/release value, the present invention aims to create musical sequences that can be used in any application where a desired emotion can be identified. The algorithm can also generate music in real-time, using an input that is not predetermined.

Many models attempting to produce emotionally affecting compositions do not rely on music theory so much as machine learning and neural network-based approaches. U.S. Pat. No. 6,297,439 (Browne) details a recursive artificial neural network system and method for automatically generating music of a given style or composer by inputting and analyzing an initial sequence of input notes. U.S. Pat. No. 10,657,934 (Kolen et al.) describes a different method for creating musical scores via a user interface where the user first selects a genre and artists or songs, which then drives the selection of musical constraints based on analyzing the artists or songs. These musical constraints are then used to provide feedback to the user where their score deviates from the musical constraints. Alternatively, U.S. Pat. No. 10,679,596 (Balassanian) determines a set of composition rules based on analyzing a plurality of tracks in a set of music content, where the rules include the number of tracks to overlay, the types of instruments to combine and selecting the next key in a progression, then using this information to inform which tracks to overlay to play at the same time. Lastly, U.S. Patent Application Publication US 2018/0322854 trains a melody prediction model for lyrics using a corpus of songs. The method then creates new melodies from new lyrics inputted by a user using probability distributions of melody features from the prediction model. Researchers have also developed composition algorithms that use neural networks and other machine learning approaches (Eck and Schmidhuber 2002; Liu and Ramakrishnan 2014). However, these kinds of models can suffer from various failure modes, such as notes or short motifs that repeat infinitely. These issues can sometimes be improved by using rules from music theory to contribute structure and give constraints, balancing the probabilities learned from training data with accepted music theory rules (Jaques et al. 2017). Probabilistic models, including some neural networks, are effective to some extent and in certain contexts, and while various workarounds for issues with machine learning composition algorithms can be implemented, issues with the core algorithm may lead one to look elsewhere for a more elegant solution.

Another approach is to combine existing segments, units, motifs, tracks or series of notes that have been shown to be musically effective into a larger musical piece or composition. U.S. Pat. No. 7,696,426 (Cope) describes a method for automatically composing new musical work based on a plurality of existing musical segments using a programmed linear retrograde recombinant musical composition algorithm. It analyzes and combines segments with pitch, duration and on-time metrics and combines the segments by matching the last note of desired/selected segments. Alternatively, U.S. Pat. No. 7,842,874 (Jehan) creates new music by listening to a plurality of music, and performing concatenative synthesis based on the listening and learning. It utilizes a spectrogram as the main analysis method and a combination of beat matching, time scaling and cross synthesis for the concatenative synthesis. U.S. Pat. No. 8,581,085 (Gannon) describes generating a musical composition from one or more portions of one or more performances of one or more musical compositions included in a database. The method then selects a portion of a pre-recorded composition based on degree of similarity using chord tones and notes in a scale associated with the chord tones. U.S. Patent Application Publication US 2020/0188790 assigns an emotion to musical motifs and then associates the motif to the desired emotion of a video game vector. The method then generates a musical composition based on these associations. Lastly, U.S. Pat. No. 8,812,144 (Balassanian) creates music by inputting a desired energy level, determining the tempo and key based on the energy level and combining at least one generated track and one loop track to create the music. These methods do not create new music so much as rearrange and transform preexisting music. Therefore, the musical breadth and depth of the resulting compositions is inherently limited to their source segments and motifs.

Overall, it is evidently extremely challenging to create an algorithm that learns to generate emotionally and musically effective sequences. A music theory-driven model that utilizes the perceived meanings and effects of the relationships between musical states is a novel and powerful approach that may be able to more effectively generate new musical sequences in real time. The simplicity and versatility of the present invention's single value “emotion” input allows for a variety of possible applications: to automatically generate a soundtrack for a movie, to compose music for a video game in real-time according to a player's actions, or to enhance a VR experience. Generated music could also be used to amplify or transform experiences not normally accompanied by music, such as scrolling through a social media feed, watching sports, or online messaging. Because the present invention uses an emotion input that changes over time, it also allows for the real time generation of novel music that appropriately matches storylines and emotional arcs rather than a single target emotion across a period of time or an entire experience.

### SUMMARY OF THE INVENTION

The present invention provides innovative techniques for making a musical choice based on a target level of musical tension. One can begin with a value that represents the target level of musical tension, as well as a domain of possible musical states. The amount of musical tension that would ensue as a result of choosing each possible next state is calculated by independently considering the horizontal and vertical tensions, then a choice is made based on the calculated tensions of the possible next states in comparison to the target level of tension. Some specific embodiments of the invention are described below.

In one embodiment, the invention provides a computer implemented method of choosing a next chord in a sequence based on an input of a target tension value as well as a domain of possible chords. The vertical and horizontal tensions that would result from choosing each chord in the domain is calculated. Considerations in calculating the vertical tension of a possible next chord include the harmonic relationships between notes in the chord, the chord quality, and the relationship between the chord and globally defined parameters. Considerations in calculating the horizontal tension of a possible next chord include comparing corresponding attributes of the current and next chords, comparing the root notes of the current and next chords, determining the notes shared in common between the current and next chords, determining the notes in the current chord that are one semitone above a note in the next chord, and checking for a match with specific predefined chord sequences. A final tension value is calculated from the vertical and horizontal tension values, then a choice is made by comparing the final tension values of each possible chord to the target tension value, and selecting the chord that is the closest match.

In another embodiment, the invention provides a computer implemented method of choosing a next note in a sequence based on an input of a target tension value as well as a domain of possible notes. The vertical and horizontal tensions that would result from choosing each note in the domain is calculated. Considerations in calculating the vertical tension of a possible next note include the relationship between the note and other musical elements present at the same time, and the relationship between the note and globally defined parameters. Considerations in calculating the horizontal tension of a possible next note include the harmonic interval between the current and next note, and checking for a match with specific predefined sequences of notes. A final tension value is calculated from the vertical and horizontal tension values, then a choice is made by comparing the final tension values of each possible note to the target tension value, and selecting the note that is the closest match.

Other features and advantages of the invention will become readily apparent upon review of the following description in association with the accompanying drawings, where the same or similar structures are designated with the same reference numerals.

### BRIEF DESCRIPTION OF THE DRAWINGS

FIG. 1 is a flow chart of a first embodiment of a system to make a musical choice.

FIG. 2 is a flow chart of an alternative embodiment of a system for generating a sequence of musical elements.

FIG. 3 is a schematic diagram of an alternative embodiment of a system for choosing a chord.

FIG. 4 is a schematic diagram of an alternative embodiment of a system for choosing a note.

FIG. 5 is a schematic diagram of an embodiment for creating an N-ary tree of musical sequences.

FIG. 6 shows a detailed schematic of a preferred form for analyzing vertical tension in a chord.

FIG. 7 shows a detailed schematic of a preferred form for analyzing horizontal tension in a chord.

FIG. 8 shows a chord abstraction framework used in the system.

FIG. 9 is a schematic diagram showing a process for determining the target TRQ (tension/release quotient) in a space shooter style video game.

FIG. 10 is a schematic block diagram of a general purpose computer upon which the preferred embodiments of the present invention can be practiced.

### DETAILED DESCRIPTION OF THE PREFERRED EMBODIMENTS

The present invention uses a jazz approach to music theory to inform generation. Jazz music theory is not exclusive to jazz music; it is simply a flexible and powerful method of abstracting, analyzing, creating, and communicating musical structures. This theory is related to but largely distinct from the classical approach to music theory. Basic jazz theory can be generalized and abstracted such that a few key concepts can be used to analyze very complex structures, and an additional benefit is that one state does not restrict the available choices for the next musical or emotional state, making it especially powerful when considering a wide variety of possible musical and emotional directions. This use of jazz theory enables the present invention to have the key advantages of being able to generate completely new music, as well as being able to create music in real time.

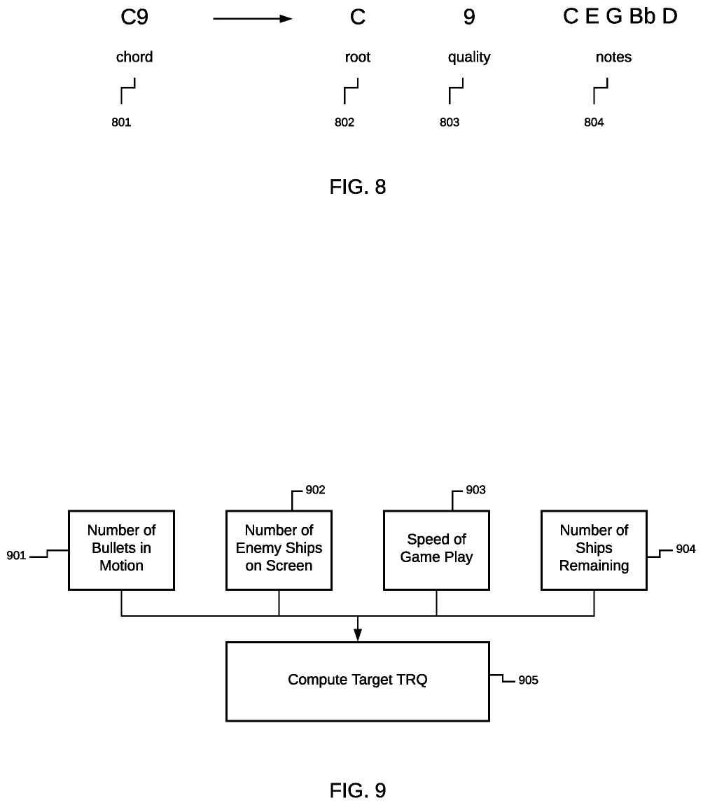

In the present invention, chords are represented by conventional jazz chord symbols, which are composed of two components: a “root” and a “quality.” The root of a chord is the tonal foundation of a chord. The chord quality determines the other notes in the chord relative to the root. FIG. 8 shows a chord abstraction framework used in the present invention for a C9 chord 801. As shown in FIG. 8, in the “C9” chord (comprised of the notes [C E G B b D] 804), “C” is the root 802 of the chord, and “9”, which represents a 9th chord, is the chord quality 803—the rest of the notes [E G B b D] are determined by the chord quality “9,” relative to C. Chord qualities determine notes relative to a root; a “9” chord only represents the notes [C E G B b D] if the root is C. The same chord quality “9” in an “A9” chord denotes a different set of notes, [A C# E G B]. However, a chord quality often behaves in a similar way regardless of its root note, so this method of representation allows chords to be analyzed in terms of their functions rather than their manifestations. More generally, maintaining a level of abstraction ensures that elements retain musical meaning; it allows for the creation and analysis of musical structures rather than individual notes.

### Algorithm Structure

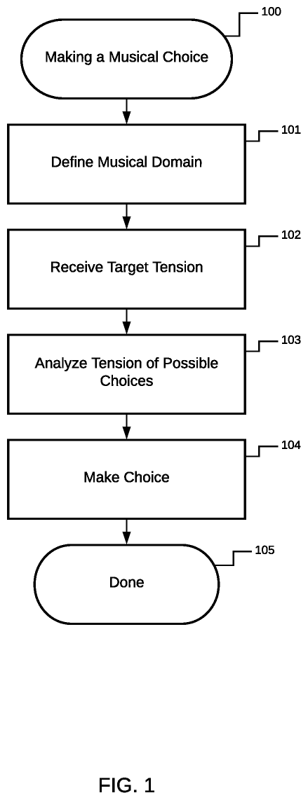

FIG. 1 is a flow chart of a system to make a music choice. The first step is to define the musical domain 101 of the decision. This may include parameters such as key, possible chord choices, scales etc. The next step is to receive the target tension 102 which is the amount of musical tension for the desired choice. Once the domain and target tension are defined, the system will then analyze the tension of all possible choices 103. Finally the system makes a musical choice 104 based on the analysis.

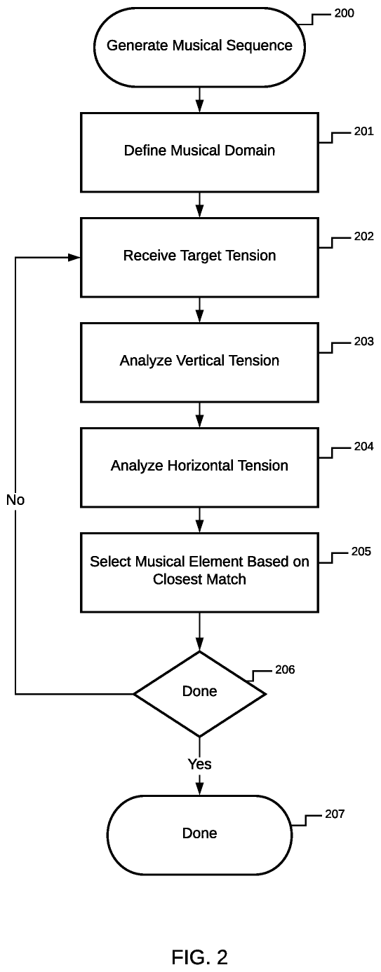

FIG. 2 is a flow chart of a system that generates a musical sequence 200. The sequence can be a chord progression, melody, rhythm, bassline, chordal accompaniment or any other musical sequence. The first step is to define the musical domain 201. Similar to FIG. 1 this may include parameters such as key, possible chord choices, scales, etc. The next step is to receive the target tension 202. Once the domain and target tension are established, the system will then analyze the vertical 203 and horizontal 204 tension of all possible choices. Next, the system selects the next musical element based on the closest match 205 to the target tension. Finally, the system either 206 iterates to the next element in the musical sequence or finishes 207.

To use the concept of tension and release in the present invention as shown in FIG. 1 and FIG. 2, the methods from jazz theory to create and release tension must be rigorized and quantized. One way to accomplish this is through a “tension/release quotient” (a “TRQ”): an integer between −10 and 10 that represents the degree of tension or release imparted by the change from the current state to a possible next state, where −10 represents the maximum amount of release and 10 represents the maximum amount of tension.

As shown in FIG. 2, a novel and powerful method to accomplish the complex task of evaluating musical tension/release is to independently analyze the “vertical” and “horizontal” significance of each musical element, then combine these considerations in a final step. Vertical significance refers to an element's relationship to other elements that are present at the given moment in time (including those held constant throughout an entire generation, such as a key), while horizontal significance refers to an element's relationship to elements present at a different time (an element's relationship to what preceded it). This approach supplies two axes of meaningful analysis of any structure. For instance, a higher degree of vertical chromaticism in a chord results in a greater, more tense, TRQ (thus a “b? 9” in a chord, such as a D b in a C chord, would result in a more tense TRQ). Horizontal significance is also considered: for example, the interval between a chord's root and the previous chord's root (always calculated as an ascending interval) is considered—a 4th interval, for instance, would result in a more released TRQ. The default TRQ is 0, and each vertical and horizontal consideration increases or decreases the value.

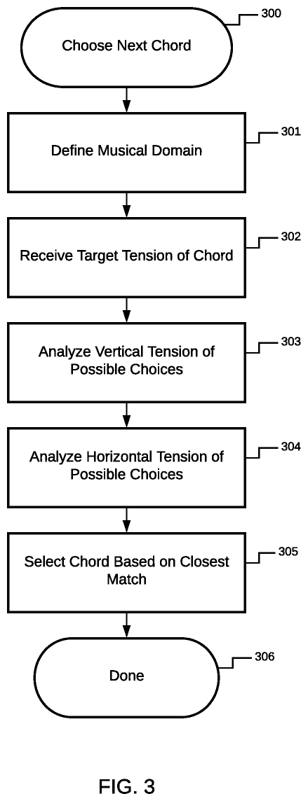

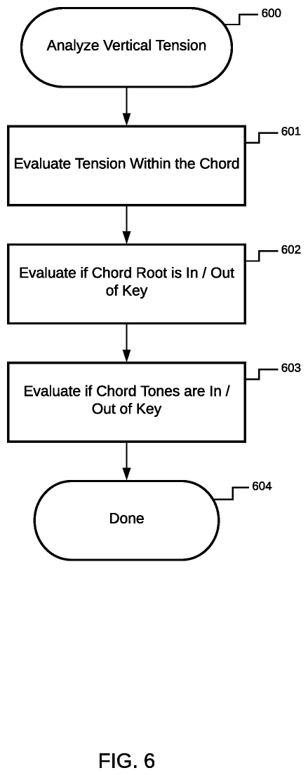

FIG. 6 shows a detailed schematic of a method for analyzing vertical tension used in the system shown in FIG. 2 and FIG. 3. The vertical factors that influence the TRQ are: tension within the chord, root note being in/out of the key, and chord tones being in/out of the key.

To analyze vertical tension 600, the system first evaluates the tension within the chord 601 by determining the chord quality (see FIG. 8). The chord quality refers to the type of chord distinct from the root note. This type of abstraction allows for the analysis of the function of chords rather than the notes themselves, as chords with the same chord quality will have similar effects on the calculated level of tension/release regardless of the notes that actually comprise the chord itself. The chord quality's effect on the level of tension/release also considers alterations of notes in the chord (sharped or flatted notes), which have the potential to increase the level of tension depending on which chord tones are being altered and in what manner.

The next step is to evaluate if the chord root is in or out of the key 602. The root of the chord is the note that the chord is constructed from, and together with the chord quality, determines the notes that comprise the chord. A root note that is outside of the key will result in an increase in the calculated tension. Considering the root note's relationship to the greater musical context independent of the rest of the chord provides a broad measure of the entire chord's relationship to the musical context, as the rest of the chord is constructed off of the root note.

Finally, the system analyzes if the chord tones themselves are in or out of the key 603. This provides a more detailed analysis of the chord's relationship to the musical context, and is a secondary, higher-resolution consideration after analyzing the root note.

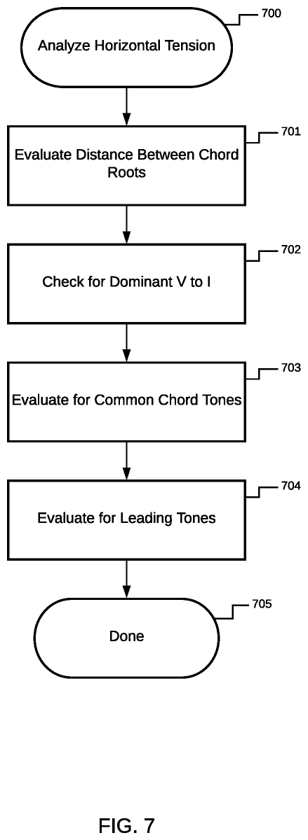

FIG. 7 shows a detailed schematic of a method for analyzing horizontal tension used in the system shown in FIG. 2 and FIG. 3. The horizontal factors that influence the TRQ are: root note interval, notes in common with previous chord, notes a half-step below a note in the previous chord (leading tones), and chord quality of the previous chord in relation to the current chord.

To analyze horizontal tension 700, the system first evaluates the distance between chord roots 701. This distance is measured in ascending semitones, and is an effective indication of harmonic movement and function. Each distance has a corresponding degree of tension or release.

Next, the method then checks for a dominant V to I sequence 702. This specific chord movement is central to harmonic movement in Western music, and is thus specifically checked for.

The third step is to evaluate for common chord tones 703. This is a measurement of the magnitude of harmonic movement—if many chord tones are shared between two chords, the magnitude of tension or release generated will be smaller.

Finally, the system evaluates for leading tones 704. Leading tones are defined as notes in a chord that are a semitone below a note in the previous chord, and are a common means of harmonic resolution. The existence of one or more leading tones results in a greater degree of release.

For instance, if the current chord is C major, the movement C major→A minor, which is diatonic, has a root note interval of a major 6th, and shares in common 2 chord tones with C major, has the slightly released TRQ. The movement C major→A7 b 9, however, has the same root note interval but is a dominant chord with a chromatic alteration (b 9) and two chord tones not in the key of C major, so it has a more tense TRQ.

The input for the present invention is an array (for a generation of fixed length) or continuous stream (for a real time generation of unknown length) of TRQ values that represents the desired tension or release of the generation over time. Depending on the application, this tension/release profile can be obtained directly from the user or from another source—for instance, if the present invention is being used to generate music to accompany a video game, the events occurring in the game could be used to produce the profile.

Before generation starts, it is necessary to define the set of possible states that the generation could output. When generating chords, this is accomplished by specifying a domain of possible roots and chord qualities. For instance, a possible domain could include the root notes [C F G], and the chord qualities [major minor 7], yielding overall possible combinations of: C major, C minor, C7, F major, F minor, F7, G major, G minor, and G7.

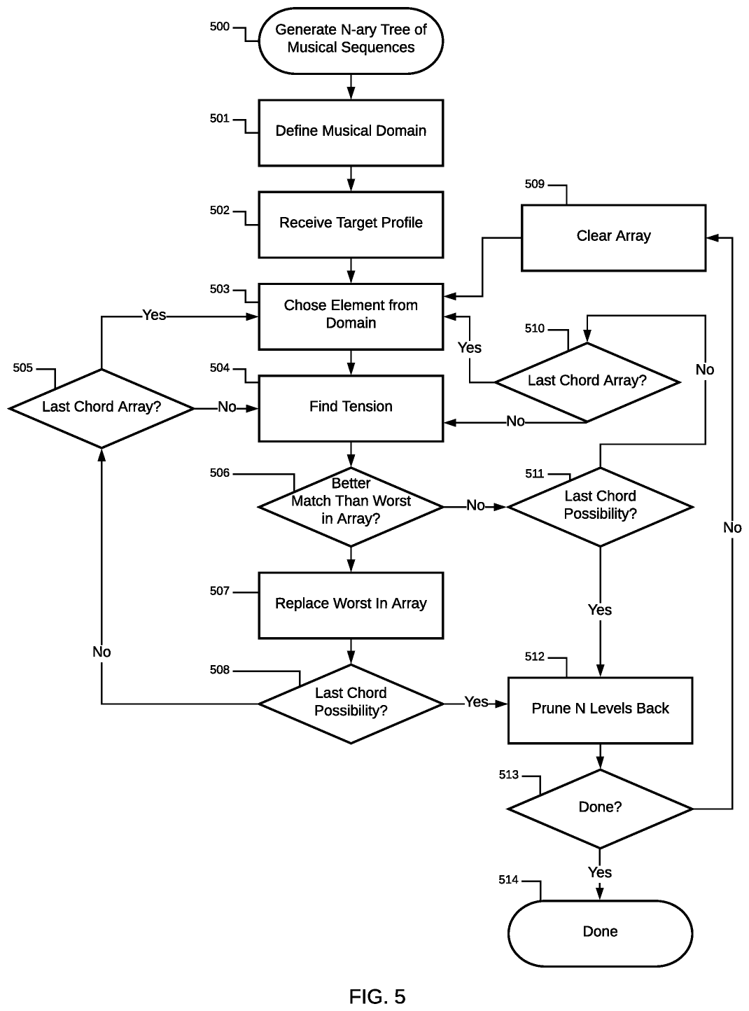

Whenever the present invention reaches a musical state, the TRQs of all possible next states are calculated, and the algorithm chooses the state with a TRQ that most closely matches the target profile. This state becomes the current state, and the process is repeated. The algorithm can be executed with multiple “threads,” where several of the closest matches are selected at each stage of the algorithm, creating an N-ary tree structure as shown in FIG. 5. At the end of generation, the best overall choice (evaluated by the sum of the deviations of the generations from the target) is selected. This results in generations that more closely match the target tension/release profile. With just a single thread, the present invention can be used for real-time generation of chords based on a TRQ input that changes in real time; for near-real-time generation, the algorithm can generate one or two states ahead and choose the best option. Since the present invention deals with the tension and release of state changes, not the actual states themselves, an initial state must be chosen at the beginning of generation.

FIG. 3 is a flow chart for a system that chooses a musical chord 300. The first step is to define the musical domain 301 of possible roots and chord qualities. The next step is to receive the target tension 302. Once the domain and target tension are established, the system will then analyze the vertical 303 and horizontal 304 tension of all possible chord choices. Next, the system selects a chord on the closest match 305 to the target tension.

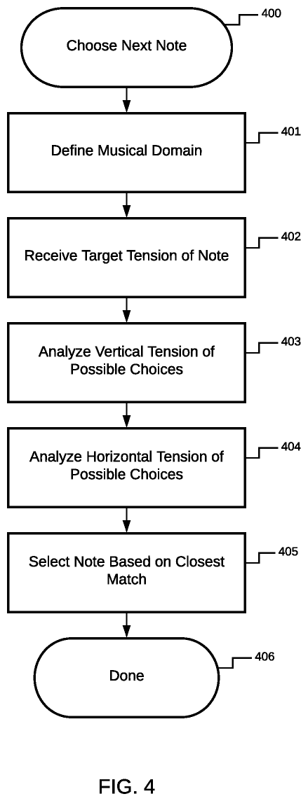

FIG. 4 is a flow chart for a system that chooses a musical note 400. The first step is to define the musical domain 401 of possible notes. The next step is to receive the target tension 402. Once the domain and target tension are established, the system will then analyze the vertical 403 and horizontal 404 tension of all possible note choices. Next, the system selects a note on the closest match 405 to the target tension.

### Example Implementation

FIG. 9 is a schematic diagram showing a process for determining the target TRQ (tension/release quotient) 905 in a spaceship shooter style video game. In the game, the TRQ is computed based on the number of bullets in motion 901, number of enemy spaceships on the screen 902, speed of play 903 and number of spaceships remaining 904. The target TRQ is calculated every second by analyzing the key tension parameters where the number of bullets in motion, number of enemy spaceships on the screen and speed of play positively correlate with a higher TRQ. In contrast, the number of spaceships remaining negatively correlates with TRQ (the more ships, the less tension). Thus, a battle situation with a large number of bullets in motion, a high number of enemy spaceships, fast play and no spaceships remaining would generate the highest level of TRQ. The generated chords are passed to a series of arpeggiators that trigger samples to create the music heard in the game. Though a straightforward example, this implementation displays how the present invention and the TRQ input can be used simply and effectively to generate new music in real time that reacts to changes in a virtual environment in real-time.

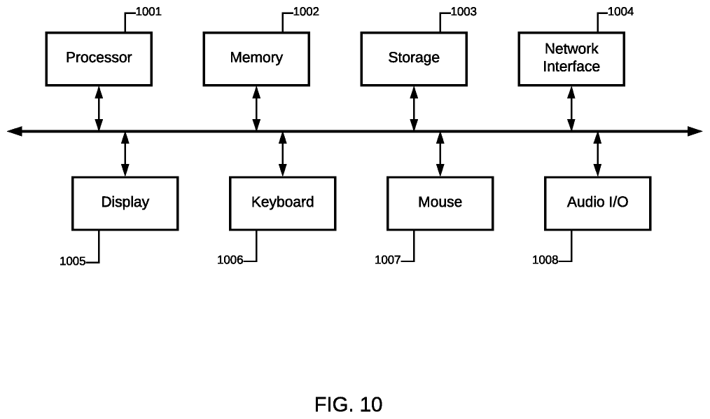

FIG. 10 is a schematic block diagram of a general purpose computer upon which the preferred embodiments of the present invention can be practiced. It should be noted that the computer could be any computational device of any size: personal computer, web server, mobile device, watches, mainframes etc.

### Alternative Embodiments

The present invention's core tension/release driven algorithm could be applied effectively to the generation of any musical structure—the TRQ would be adapted to calculate the tension or release imparted by each possible musical choice. If multiple musical structures are being generated (for instance, chords and melody), the tension or release of the individual components would be calculated, as well as the tension or release created by their coexistence.

The simplicity and flexibility of the single tension/release input allows the present invention to be adapted for a large variety of applications. Creators producing games, movies, installations, or VR experiences could use the present invention to create music that conforms to the intended tone. Using sentiment analysis, the emotional content of a text source could be used to calculate a TRQ over time, so the algorithm could be used to generate musical accompaniment for an online messaging conversation, e-book, or social network feed.

1. A computer implemented method of making a musical choice, comprising:
defining a domain of at least one musical state;
inputting a target musical tension value;
analyzing the vertical musical tension of at least one possible musical choice;
analyzing the horizontal musical tension of at least one possible musical choice;
making a musical choice based on the vertical and horizontal tensions of possible next states in comparison to the target tension value.

2. The method of claim 1, wherein the vertical tension of a possible next state is analyzed by considering the relationships between coexisting elements of the next state.

3. The method of claim 1, wherein the vertical tension is analyzed by considering the relationship between a particular element present in the next state and any globally defined parameter.

4. The method of claim 1, wherein the horizontal tension of a possible next state is analyzed by comparing corresponding elements of the current and next states.

5. A computer implemented method for choosing a next chord, comprising:
defining a musical domain of chords;
inputting a target musical tension value;
analyzing the vertical musical tension of at least one possible next chord;
analyzing the horizontal musical tension of at least one possible next chord;
selecting a next chord based on the closest match to the target tension.

6. The method of claim 5, wherein the vertical tension of a possible next chord is analyzed by considering the harmonic relationships between the notes that comprise the next chord.

7. The method of claim 5, wherein the vertical tension of a possible next chord is analyzed by considering the chord quality of the next chord.

8. The method of claim 5, wherein the vertical tension of a possible next chord is analyzed by considering the relationship between a particular note present in the next chord and any globally defined parameters.

9. The method of claim 5, wherein the vertical tension of a possible next chord is analyzed by considering the relationship between the notes that comprise the next chord and a globally defined musical key.

10. The method of claim 5, wherein the horizontal tension of a possible next chord is analyzed by comparing the chord quality and number of notes in the current and next chords.

11. The method of claim 5, wherein the horizontal tension of a possible next chord is analyzed by comparing the root notes of the current and next chords.

12. The method of claim 5, wherein the horizontal tension of a possible next chord is analyzed by determining the notes shared in common between the current and next chords.

13. The method of claim 5, wherein the horizontal tension of a possible next chord is analyzed by determining the number of notes in the current chord that are one semitone above a note in the next chord.

14. The method of claim 5, wherein the total tension is calculated by computing the sum of the horizontal and vertical tensions.

15. The method of claim 5, wherein the total tension is calculated to be the greater of the horizontal and vertical tensions.

16. A computer implemented method for choosing a next note, comprising:
defining a musical domain of notes;
inputting a musical target tension value;
analyzing the vertical musical tension of at least one possible next note;
analyzing the horizontal musical tension of at least one possible next note;
selecting a next note based on the closest match to the target tension.

17. The method of claim 16, wherein the vertical tension is analyzed by considering the relationship between a possible next note and any other musical elements present at the same time.

18. The method of claim 16, wherein the vertical tension is analyzed by considering the relationship between a possible next note and any globally defined parameters.

19. The method of claim 16, wherein the vertical tension is analyzed by considering the relationship between a possible next note and a globally defined musical key.

20. The method of claim 16, wherein the horizontal tension of a possible next note is analyzed by considering the interval between the current note and a possible next note.
